(19) United States
(12) Patent Application Publication
(10) Pub. No.: US 2015/0285477 A1
(43) Pub. Date: Oct. 8, 2015

(54) ADJUSTABLE MOUNTING ASSEMBLY FOR LIGHT FIXTURE POLE AND METHODS OF INSTALLATION THEREOF

(71) Applicant: ABL IP Holding LLC, Conyers, GA (US)

(72) Inventors: Daniel Vincent Sekowski, Loganville, GA (US); Brent James Smith, McDonough, GA (US); Mark Edwin Jennings, Conyers, GA (US)

(73) Assignee: ABL IP Holding LLC, Conyers, GA (US)

(21) Appl. No.: 14/244,073

(22) Filed: Apr. 3, 2014

(51) Int. Cl. F21V 21/14; F21V 21/116; F21S 6/00

(52) U.S. Cl. CPC F21V 21/14; F21S 6/005; F21V 21/116

(57) ABSTRACT

A mounting assembly for securing a luminaire to a light pole includes an adapter and a support bracket supporting a plurality of adapter wedges. The adapter includes an upper portion and a lower portion. The lower portion is tapered such that the diameter of the lower portion proximate the upper portion is greater than the diameter of the lower portion distal the upper portion. A plurality of adapter wedges are mounted to the mounting assembly, and have a first side facing outward from the mounting assembly and a tapered second side facing the lower portion of the adapter. A luminaire is attached to the adapter. The adapter and support bracket provides for installation in light poles having varying inside diameters.

### FIELD OF THE INVENTION

The present invention generally relates to a mounting assembly for a light fixture pole, and in particular to an adjustable mounting assembly that can be used to secure a light fixture to poles of varying diameters.

### BACKGROUND

Lighting fixtures are typically attached to a light fixture pole by securing the fixture to a bracket or other mounting apparatus. Wiring for the light fixture runs down the center of the pole and ultimately the power source located away from the base of the pole.

A typical lighting fixture for use with a lighting fixture pole includes a luminaire and a mounting assembly. The luminaire contains the light source and an optic which protects the light source and disperses light from the light source into the area to be illuminated. The mounting assembly provides a structure for mounting the luminaire to the pole. The assembly may be made up of a wedge and an extrusion, with the extrusion having an outside diameter that is slightly less than the inside diameter of the pole and the wedge having an outside diameter slightly greater than the inside diameter of the pole. During installation, the wedge and extrusion are attached to a threaded rod and the wedge is compressed into the extrusion, causing the extrusion to contact the inner diameter of the pole, securing the assembly in place.

Light fixture poles are not all the same, however, and can be found in various, non-standard sizes having different inner diameters. It will be apparent that when the inner diameter of the pole is changed, the size of the extrusion must also be changed in order to maintain the interference fit between the extrusion and the pole. As a result, a manufacturer must make several different sizes of extrusions to accommodate different pole sizes, and an installer must carry an inventory of different sized extrusions for use in different installation projects, neither of which is efficient from the standpoint of cost, storage, waste and other considerations.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Adjustable mounting assemblies for installing luminaires on light fixture poles, and methods for installing the mounting assemblies on the light fixture poles, are described herein.

### BRIEF DESCRIPTION OF THE DRAWINGS

Illustrative embodiments of the present invention are described in detail below with reference to the following drawing figures:

FIG. 1 is an exploded top perspective view of an adjustable mounting assembly of the present invention.

FIG. 1A is an exploded side perspective view of a support bracket with adapter wedges of the adjustable mounting assembly of FIG. 1.

FIG. 2 is a side cross section view of an adjustable mounting assembly installed in a light pole having a first diameter.

FIG. 3 is a side cross section view of an adjustable mounting assembly installed in a light pole having a smaller second diameter.

FIG. 4 is another exploded top perspective view of an adjustable mounting assembly of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

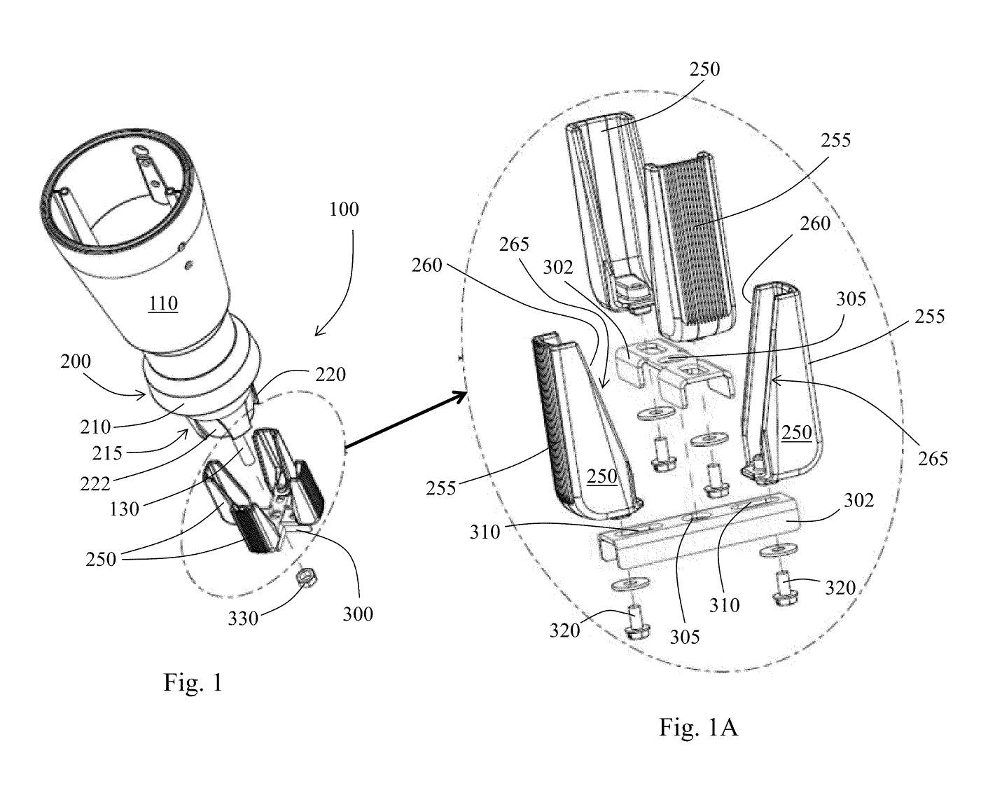

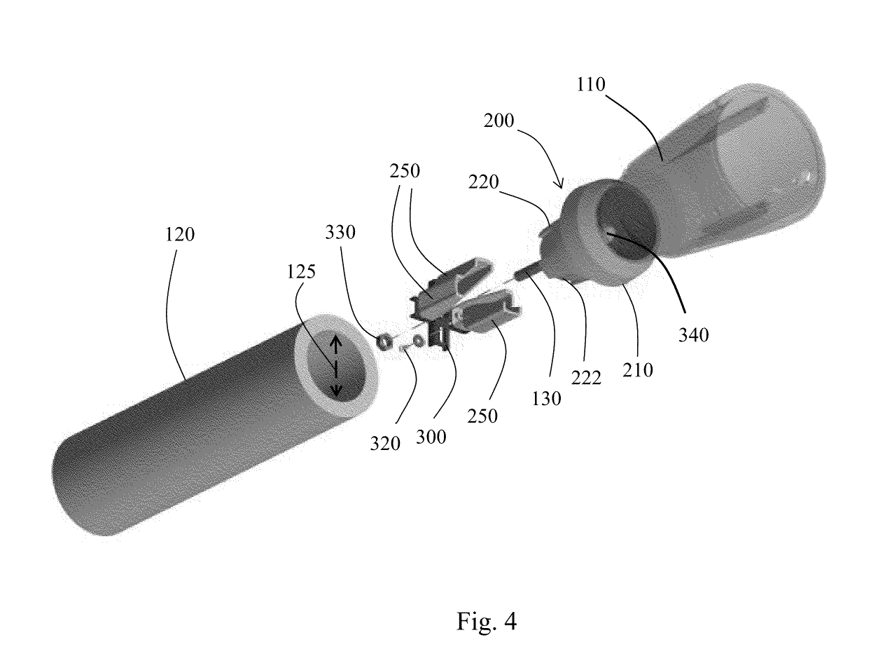

With reference to FIGS. 1-4, embodiments of the invention relate to an adjustable mounting assembly 100 for securing a luminaire 110 to a light pole 120. The mounting assembly 100 includes an adapter 200, a plurality of adapter wedges 250, a support bracket 300 and a threaded adjustment rod 130.

The adapter 200 includes an upper portion 210 and a lower portion 220 having a diameter. The lower portion 220 includes a taper 215 such that the diameter of the lower portion 220 proximate the upper portion 210 is greater than the diameter of the lower portion 220 distal the upper portion 210. The adapter 200 has an adapter aperture running through the center thereof.

The plurality of adapter wedges 250 include a vertical first side 255 second side 260 having a taper 265. The first side 255 faces outward from the mounting assembly 100, towards the inner diameter 125 of the light pole 120 and the second side 260 faces the tapered lower portion 220 of the adapter 200, toward the center of the light pole 120.

The support bracket 300 retains the plurality of adapter wedges 250 and includes a plurality of openings 310 corresponding to the number of adapter wedges 250. As shown in the figures, the support bracket retains four adapter wedges 250 on two mating arms 302 secured in their center in the form of an “X”, but it will be understood that the support bracket could have any suitable shape and be of any construction as long as it can retain the adapter wedges 250 as described herein. For example, the support bracket 300 could have three mating arms 302 for supporting six adapter wedges 250. Further, the support bracket 300 could be integrally formed—e.g., a polymeric or aluminum one-piece construction. The support bracket 300 includes a mounting assembly aperture 305 located in the center thereof.

Each of the plurality of openings 310 receives an adapter wedge fastener 320 for attaching the adapter wedge 250 to the support bracket 300. The openings 310 are elongated and oriented radially relative to the center of the support bracket 300. In this way, an adapter wedge 250 is able to translate or slide within an elongated opening 310 when mounted on the support bracket 300, as described in more detail below.

To secure each of the plurality of adapter wedges 250 to the support bracket 300, an adapter wedge fastener 320, such as but not limited to a bolt or screw, is inserted through the opening 310 and attached to the adapter wedge 250. The adapter wedge fastener 320 is tightened to secure the adapter wedge 250 to the support bracket 300, but the adapter wedge 250 is still loose enough on the support bracket 300 so that it can slide within the elongated opening 310 relative to the support bracket 300 as the mounting assembly 100 is installed on the light pole 120.

To install the mounting assembly 100 on the light pole 120, the support bracket 300 with the plurality of adapter wedges 250 installed thereon is placed on the threaded adjustment rod 130 through mounting assembly aperture 305 and retained thereon by a lower fastener 330, such as but not limited to a nut, mounted on the threaded adjustment rod 130. The adapter 200 is placed on the threaded adjustment rod 130 through the adapter aperture above the support bracket 300 with the lower portion 220 thereof proximate the support bracket 300. An upper fastener 340 such as but not limited to a nut is placed over the adapter 200 onto the threaded adjustment rod 130. In this manner, the lower fastener 330 supports the support bracket 300, and the plurality of adapter wedges 250—and in particular the tapered second side 260 of the adapter wedge 250—contacts the tapered lower portion 220 of the adapter 200. To finish the installation of the mounting assembly 100 on the light pole 120, the upper fastener 340 is tightened, causing the support bracket 300 to move upwardly on the threaded adjustment rod 130. As the support bracket 300 moves upwardly, the plurality of adapter wedges 250 slide up the lower portion 220 of the adapter 200 and move radially outwardly from the support bracket 300 along the openings 310. Tightening of the upper fastener 340 is continued until the first side 255 of the adapter wedges contacts the inside surface of the light pole 120 to secure the adapter 200 in position within the light pole 120. A luminaire 110 can then be installed onto the adapter 200 using conventional means.

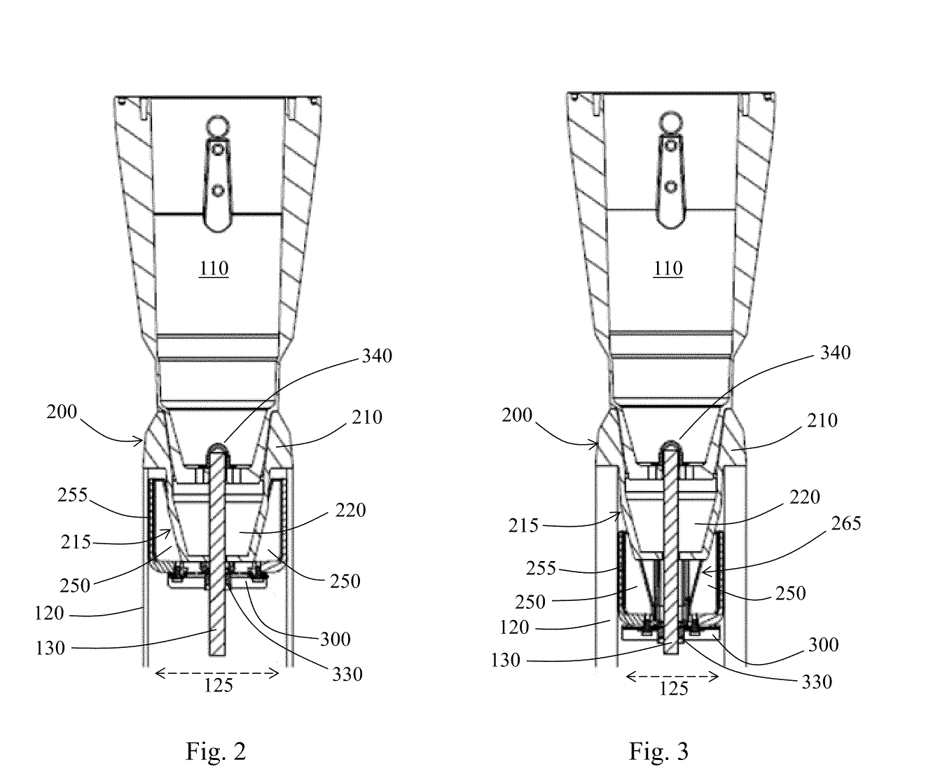

The mounting assembly 100 described above is thus suitable for securing a luminaire to light poles 120 having varying inner diameters 125, as shown in FIGS. 2 and 3. For a light pole 120 having a larger inner diameter 125 (FIG. 2), the plurality of adapter wedges 250 will slide farther outward from the support bracket 300 and farther upward along the tapered lower portion 220 of the adapter 200. For a light pole 120 having a smaller inner diameter 125, the plurality of adapter wedges 250 will contact the interior surface of the light pole 120 sooner and will thus not slide outward from the support bracket 300 as far and will not move as far upward along the tapered lower portion 220 of the adapter 200. In some embodiments, the mounting assembly 100 may be used with light poles 120 having an inner diameter 125 of from about 3″ to 5″, although it could certainly be used with light poles having other inner diameters.

In certain embodiments, the lower portion 220 of the adapter 200 has a taper 215 that corresponds to the taper 265 on the second side 260 of the plurality of adapter wedges 250, so that when the adapter wedge 250 slides up the tapered lower portion 220 of the adapter 200 and outward along the openings 310, the second side 260 of the plurality of adapter wedges 250 and tapered lower portion 220 of the adapter 200 maintain substantial contact with one another. This could improve contact between the plurality of adapter wedges 250 and adapter 200 and prevent relative rotational movement therebetween.

In some embodiments, the lower portion 220 of the adapter 200 includes a plurality of recesses 222 corresponding to the number of adapter wedges 250, and each of the plurality of adapter wedges 250 engage a respective recess 222 in the adapter 200 to prevent relative rotational movement between the plurality of adapter wedges 250 and the adapter 200. The plurality of recesses 222 may, but do not have to, have a taper 215 that corresponds to the taper 265 of the tapered second side 260 of the adapter wedge 250. This would provide good contact between the tapered second side 260 of the adapter wedge 250 and the recess 222.

While the figures show the mounting assembly 100 as including four adapter wedges 250, it will be understood that a mounting assembly 100 according to the invention may have fewer or more adapter wedges, for example two adapter wedges, three adapter wedges, or more than four adapter wedges.

Further, as shown in, e.g., FIG. 1A, the first side 255 of one or more of the plurality of adapter wedges 250 may have a textured surface that will provide a good contact surface with the inside surface/inner diameter 125 of the light pole 120 and thus minimize relative movement therebetween when the mounting assembly 100 is installed on the light pole 120. The textured surface could be a surface feature integrally formed in the surface, such as but not limited to a plurality of ridges, or could be a feature applied to the first side 255 of the adapter wedge 250, such as but not limited to a rubberized coating.

The adapter 200, plurality of adapter wedges 250, and support bracket 300 may each independently be formed of any suitable material, such as but not limited to cast aluminum, steel, and polymeric materials. In one particular embodiment, each of these components is formed from cast aluminum.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A mounting assembly for securing a luminaire to a light pole having an inner diameter, comprising:
an adapter comprising an upper portion and a lower portion comprising a diameter, wherein the lower portion comprises a taper such that the diameter of the lower portion proximate the upper portion is greater than the diameter of the lower portion distal the upper portion;
a plurality of adapter wedges comprising a first side and a second side comprising a taper, the first side facing outward from the mounting assembly and the second side facing the lower portion of the adapter; and
a support bracket retaining the plurality of adapter wedges and positioned more proximate the lower portion of the adapter than the upper portion of the adapter.

2. The mounting assembly of claim 1, wherein:
the support bracket is configured to retain the plurality of adapter wedges on a threaded adjustment rod within the light pole, and
the second side of the plurality of adapter wedges are slidable relative to the lower portion of the adapter such that, when the support bracket is moved upwards along the threaded adjustment rod toward the upper portion of the adapter, the plurality of adapter wedges slide up the lower portion of the adapter and move radially outwardly so that the first side of the plurality of adapter wedges contacts the inner diameter of the light pole.

3. The mounting assembly of claim 1, wherein the lower portion of the adapter comprises a plurality of recesses corresponding to the number of adapter wedges, and each of the plurality of adapter wedges engages a respective recess in the adapter to prevent relative rotational movement between the plurality of adapter wedges and the adapter.

4. The mounting assembly of claim 2, wherein the support bracket comprises a plurality of openings corresponding to the number of adapter wedges, each of the plurality of openings being adapted to receive a fastener for mounting an adapter wedge to the support bracket, wherein each of the plurality of openings are elongated so as to allow each of the plurality of adapter wedges to slide relative to the support bracket after mounting.

5. The mounting assembly of claim 1, wherein the mounting assembly comprises at least three adapter wedges.

6. The mounting assembly of claim 1, wherein the first side of the plurality of adapter wedges is textured so as to minimize relative movement between the first side of the plurality of adapter wedges and the inner diameter of the light pole when the mounting assembly is installed on the light pole.

7. The mounting assembly of claim 2, wherein the taper on the second side of the plurality of adapter wedges corresponds to the taper on the lower portion of the adapter such that, when an adapter wedge slides up the lower portion of the adapter, the second side of the plurality of adapter wedges and the lower portion of the adapter maintain substantial contact with one another.

8. A method for installing a luminaire to a light pole having an inner diameter using a mounting assembly, the mounting assembly comprising:
an adapter comprising an upper portion and a lower portion comprising a diameter, wherein the lower portion comprises a taper such that the diameter of the lower portion proximate the upper portion is greater than the diameter of the lower portion distal the upper portion;
a plurality of adapter wedges comprising a first side and a second side comprising a taper, the first side facing outward from the mounting assembly and the second side facing the lower portion of the adapter; and
a support bracket retaining the plurality of adapter wedges and positioned more proximate the lower portion of the adapter than the upper portion of the adapter,
the method comprising:
mounting the support bracket on a threaded adjustment rod located within the light pole;
mounting the adapter on the threaded adjustment rod above the support bracket; and
causing the support bracket to move up the threaded adjustment rod such that the plurality of adapter wedges mounted on the support bracket contact and slide up the lower portion of the adapter and move radially outwardly so that the first side of the plurality of adapter wedges contacts the inner diameter of the light pole.

9. The method of claim 8, wherein the lower portion of the adapter comprises a plurality of recesses corresponding to the number of adapter wedges,
the method further comprising causing the plurality of adapter wedges to engage a respective recess in the adapter to prevent relative rotational movement between the plurality of adapter wedges and the adapter.

10. The method of claim 8, wherein the support bracket comprises a plurality of elongated openings corresponding to the number of adapter wedges, each of the plurality of elongated openings being adapted to receive a fastener for mounting the plurality of adapter wedges to the support bracket,
the method further comprising causing the plurality of adapter wedges to slide relative to the support bracket as the plurality of adapter wedges slide up the lower portion of the adapter.

11. The method of claim 8, wherein the first side of the plurality of adapter wedges is textured,
the method further comprising minimizing relative movement between the first side of the plurality of adapter wedges and the inner diameter of the light pole when installing the mounting assembly on the light pole.

12. The method of claim 8, wherein the taper on the second side of the plurality of adapter wedges corresponds to the taper of the lower portion of the adapter,
the method further comprising causing the lower portion of the adapter and the second side of the plurality of adapter wedges to maintain substantial contact with one another as the support bracket moves up the threaded adjustment rod.
